(19) United States
(12) Patent Application Publication
(10) Pub. No.: US 2008/0292740 A1
(43) Pub. Date: Nov. 27, 2008

(54) SHEET/FILM MOLDING APPARATUS AND SHEET/FILM MOLDING METHOD

(76) Inventors: Masaru Taguchi, Numazu-shi (JP); Takayoshi Sano, Fuji-shi (JP); Takashi Hirose, Numazu-shi (JP)

Correspondence Address: DLA PIPER US LLP, P. O. BOX 9271, RESTON, VA, 20195, US

(21) Appl. No.: 12/126,202

(22) Filed: May 23, 2008

(30) Foreign Application Priority Data
May 25, 2007 (JP) 2007-139611

(51) Int. Cl. B29C 47/32

(52) U.S. Cl. 425/224

(57) ABSTRACT

A sheet/film molding apparatus includes: a main roll sandwiches and presses, with a touch roll, a resin molten sheet and conveys the sandwiched and pressed resin sheet; and a separating roll separates the resin sheet from an outer peripheral surface of the main roll and conveys the resin sheet. The separating roll has a rubber roll and a metal elastic external cylinder having the rubber roll housed therein and being eccentrically positioned to the rubber roll and thin and easily elastically deformed. Cooling water is supplied between the rubber roll of the separating roll and the metal elastic external cylinder. The resin sheet between the main roll and the metal elastic external cylinder is cooled by allowing the rubber roll to make pressure contact with an inner peripheral surface thereof. The separating roll separates the resin sheet from the outer peripheral surface of the main roll.

### BACKGROUND OF THE INVENTION

1. Field of the Invention

The present invention relates to a sheet/film molding apparatus and a sheet/film molding method for continuously molding, from a molten resin extruded by a T-die, a long resin thin film body (hereinafter referred to as a resin sheet) such as a resin sheet and a resin film.

2. Description of the Related Art

As this kind of conventional sheet/film molding apparatus, there is one disclosed in Japanese Patent Application Publication No. Hei 10-315304 (Patent Document 1). As shown in FIG. 1, a sheet/film molding apparatus 100 includes: a T-die 102 connected to an extruding machine 101; a touch roll 104 and an embossing roll 105 that is a main roll, both of which sandwich and press a resin sheet 103 in a molten state therebetween, the resin sheet 103 being extruded from the T-die 102; a cold air cooling device 106 which is disposed at a position close to and facing the resin sheet 103 just before being separated from an outer peripheral surface of the embossing roll 105; and a separating roll 107 disposed at a position, away from the embossing roll 105, and on a conveying downstream side of the embossing roll 105. Moreover, on a conveying downstream side of the separating roll 107, a plurality of annealing rolls 108 are provided. Furthermore, a pair of take-up rolls 109 is provided on a conveying downstream side of the annealing rolls 108.

In the above configuration, the resin sheet 103 in the molten state, which is extruded from the T-die 102, is subjected to embossing transfer at a position sandwiched and pressed between the touch roll 104 and the embossing roll 105. The resin sheet 103 subjected to the embossing transfer is cooled below a glass transition temperature of resin by cold air from the cold air cooling device 106, and is separated from the embossing roll 105. The resin sheet 103 separated from the embossing roll 105 is conveyed to the separating roll 107, the plurality of annealing rolls 108 and the pair of take-up rolls 109 to be formed into a product sheet.

According to the conventional example described above, at the position where the embossing transfer is performed by the touch roll 104 and the embossing roll 105 immediately after the resin sheet is extruded from the T-die 102, the temperature of the resin sheet 103 is set to be equal to or higher than the glass transition temperature of resin. Thus, high fluidity of the resin allows accurate embossing transfer on the resin sheet 103. Moreover, at the position where the resin sheet 103 is separated from the embossing roll 105, the temperature of the resin sheet 103 is lowered below the glass transition temperature by the cold air from the cold air cooling device 106. As a result, the fluidity of the resin is lost and thus the resin sheet 103 is smoothly separated. Accordingly, surface processability (embossability) as well as detachability of the resin sheet 103 can be improved.

Moreover, in the conventional example, there has also been proposed a configuration in which a cooling roll is provided instead of the cold air cooling device 106 and the cooling roll presses the embossing roll 105 while sandwiching and pressing the resin sheet 103 therebetween.

However, in the conventional sheet/film molding apparatus 100 and method described above, the cold air cooling device 106 or the cooling roll is disposed at the position close to and facing the embossing roll 105. Thus, there is a problem that the number of parts is increased, the apparatus is increased in size, an installation space is increased and the like. Moreover, there are also the following problems.

Specifically, in the case where the cold air cooling device 106 is provided, when the resin sheet 103 at the start is set on the embossing roll 105, the cold air cooling device 106 close to the outer periphery of the embossing roll 105 gets in the way. In order to avoid such a situation, it is required to provide a mechanism for moving back and forth the cold air cooling device 106. Moreover, when the cold air discharged from the cold air cooling device 106 passes a lateral surface of the embossing roll 105 and touches the resin sheet 103 immediately after being extruded from the T-die 102, the air causes disturbance to molding of the resin sheet 103. Thus, it is required to take measures to prevent the disturbance. Furthermore, the cold air to be discharged from the cold air cooling device 106 has to be managed and controlled so as to be uniform in a width direction of the embossing roll 105 and to have constant temperature, air flow and wind pressure over time.

In the case where the cooling roll is provided, it is not easy to increase cooling capacity of the cooling roll. Specifically, in order to increase the cooling capacity of the cooling roll, a metal roll is generally used as the cooling roll. However, since the metal roll has high rigidity, a width in which the metal roll is brought into contact with the resin sheet 103 between the embossing roll 105 and the metal roll is very small. Thus, in many cases, a sufficient cooling effect cannot be achieved. Accordingly, in order to obtain a good resin sheet 103, an adjustable range of molding conditions, such as a resin temperature, a roll temperature, a molding speed and a thickness of the resin sheet 103, is significantly limited. As a result, desired molding conditions cannot be implemented due to insufficient cooling capacity of the cooling roll. Thus, productivity is deteriorated.

In the case where a dedicated part for cooling the resin sheet 103 is added as described above, there arise various problems other than the increases in the number of parts, in the size of the apparatus, in the installation space, and the like.

### SUMMARY OF THE INVENTION

The present invention was made in consideration of the foregoing problems. Accordingly, it is an object of the present invention to provide a sheet/film molding apparatus and a sheet/film molding method, which can improve surface processability as well as detachability of a resin sheet without adding dedicated parts for cooling the resin sheet.

In order to achieve the above object, a first aspect of the present invention is a sheet/film molding apparatus including: a touch roll; a main roll which sandwiches and presses, with the touch roll, a resin sheet extruded in a molten state from a T-die, and which conveys the sandwiched and pressed resin sheet along an outer peripheral surface thereof; and a separating roll which separates the resin sheet from the outer peripheral surface of the main roll, and which conveys the separated resin sheet along an outer peripheral surface thereof. In the above configuration, the separating roll has a rubber roll and a metal elastic external cylinder which has the rubber roll housed therein, which is eccentrically positioned to the rubber roll, and which is thin and easily elastically deformed. A cooling medium holding chamber into which a cooling medium is supplied is provided between the rubber roll and the metal elastic external cylinder. The resin sheet between the main roll and the metal elastic external cylinder is cooled by allowing the rubber roll to make pressure contact with an inner peripheral surface of the metal elastic external cylinder. The separating roll separates the resin sheet from the outer peripheral surface of the main roll.

According to the first aspect of the present invention, at the position where the resin sheet is sandwiched and pressed between the main roll and the touch roll immediately after the resin sheet is extruded from the T-die, a temperature of the resin sheet is set to be equal to or higher than a glass transition temperature of resin. Thus, high fluidity of the resin allows accurate surface processing to be performed by the main roll. Moreover, within a range in which the separating roll makes pressure contact with the main roll with the resin sheet sandwiched and pressed therebetween, the metal elastic external cylinder of the separating roll is thin and easily elastically deformed. Moreover, the metal elastic external cylinder is pressed against the outer peripheral surface of the main roll with a certain pressure-contact width. Thus, the resin sheet is cooled over the pressure-contact width by the metal elastic external cylinder cooled by the cooling medium inside. Therefore, at a position where the resin sheet is separated from the main roll, the temperature of the resin sheet is lowered below the glass transition temperature. As a result, the fluidity of the resin is lost and thus the resin sheet is smoothly separated. As described above, the separating roll also serves as a cooler configured to cool the resin sheet. Thus, surface processability as well as detachability of the resin sheet can be improved without adding dedicated part for cooling the resin sheet.

Moreover, the resin sheet separated from the main roll is immediately conveyed along the metal elastic external cylinder of the separating roll. Thus, since the resin sheet is continuously cooled by the thin metal elastic external cylinder, there is also an advantage that cooling efficiency is better than that in the conventional case.

A second aspect of the present invention according to the first aspect is that, in the sheet/film molding apparatus according to the first aspect, the rubber roll is rotated and driven by a drive source.

According to the second aspect of the present invention, in addition to the effects of the first aspect, the resin sheet can be separated from the main roll while applying tension to the resin sheet in a conveying direction by the separating roll. Thus, the resin sheet can be separated without causing the sheet to be bent, wrinkled or the like.

A third aspect of the present invention according to the first or second aspect is that, in the sheet/film molding apparatus according to the first or second aspect, the main roll is set to a temperature equal to or higher than a glass transition temperature of the resin sheet.

According to the third aspect of the present invention, in addition to the effects of the first or second aspect, at the position where the metal elastic external cylinder makes pressure contact with the main roll with the resin sheet interposed therebetween, the main roll is cooled at the spot around the pressure contact position by the metal elastic external cylinder. Thus, the temperature of the main roll may be temporarily lowered below the glass transition temperature. However, the set temperature of the main roll is equal to or higher than the glass transition temperature of the resin. Thus, the temperature of the main roll is set back to be equal to or higher than the glass transition temperature of the resin while the main roll is rotated to the pressing position with the touch roll. Therefore, when the resin sheet is subjected to surface processing by being sandwiched and pressed between the main roll and the touch roll, the temperature of the resin sheet can be surely maintained to be equal to or higher than the glass transition temperature. Thus, the surface processability of the resin sheet can be surely improved.

A fourth aspect of the present invention is a sheet/film molding method including the steps of: sandwiching and pressing, between a main roll and a touch roll, a resin sheet extruded in a molten state from a T-die; separating the resin sheet from the main roll by use of a separating roll, the resin sheet being conveyed along an outer peripheral surface of the main roll; and conveying the separated resin sheet along an outer peripheral surface of the separating roll. In the above configuration, the separating roll has a rubber roll and a metal elastic external cylinder which has the rubber roll housed therein, which is eccentrically positioned to the rubber roll, and which is thin and easily elastically deformed. A cooling medium is supplied between the rubber roll of the separating roll and the metal elastic external cylinder. The resin sheet between the main roll and the metal elastic external cylinder of the separating roll is cooled by allowing the rubber roll of the separating roll to make pressure contact with an inner peripheral surface of the metal elastic external cylinder. The separating roll separates the resin sheet from the outer peripheral surface of the main roll.

According to the fourth aspect of the present invention, at the position where the resin sheet is sandwiched and pressed between the main roll and the touch roll immediately after the resin sheet is extruded from the T-die, a temperature of the resin sheet is set to be equal to or higher than a glass transition temperature of resin. Thus, high fluidity of the resin allows accurate surface processing to be performed by the main roll. Moreover, within a range in which the separating roll makes pressure contact with the main roll with the resin sheet sandwiched and pressed therebetween, the metal elastic external cylinder of the separating roll is thin and easily elastically deformed. Moreover, the metal elastic external cylinder is pressed against the outer peripheral surface of the main roll with a certain pressure-contact width. Thus, the resin sheet is cooled over the pressure-contact width by the metal elastic external cylinder cooled by the cooling medium inside. Therefore, at a position where the resin sheet is separated from the main roll, the temperature of the resin sheet is lowered below the glass transition temperature. As a result, the fluidity of the resin is lost and thus the resin sheet is smoothly separated. As described above, the separating roll also serves as a cooler configured to cool the resin sheet. Thus, surface processability as well as detachability of the resin sheet can be improved without adding dedicated part for cooling the resin sheet.

Moreover, the resin sheet separated from the main roll is immediately conveyed along the metal elastic external cylinder of the separating roll. Thus, since the resin sheet is continuously cooled by the thin metal elastic external cylinder, there is also an advantage that cooling efficiency is better than that in the conventional case.

A fifth aspect of the present invention according to the fourth aspect is that, in the sheet/film molding method according to the fourth aspect, the rubber roll of the separating roll is rotated and driven by a drive source.

According to the fifth aspect of the present invention, in addition to the effects of the fourth aspect, the resin sheet can be separated from the main roll while applying tension to the resin sheet in a conveying direction by the separating roll. Thus, the resin sheet can be separated without causing the sheet to be bent, wrinkled or the like.

A sixth aspect of the present invention according to the fourth or fifth aspect is that, in the sheet/film molding method according to the fourth or fifth aspect, a temperature of the resin sheet when the resin sheet is sandwiched and pressed between the main roll and the touch roll is set to be equal to or higher than a glass transition temperature of the resin.

According to the sixth aspect of the present invention, in addition to the effects in the fourth or fifth aspect, at the position where the separating roll makes pressure contact with the main roll with the resin sheet interposed therebetween, the main roll is cooled at the spot around the pressure contact position by the metal elastic external cylinder. Thus, the temperature of the main roll may be temporarily lowered below the glass transition temperature. However, the set temperature of the main roll is equal to or higher than the glass transition temperature of the resin. Thus, the temperature of the main roll is set back to be equal to or higher than the glass transition temperature of the resin while the main roll is rotated to the pressing position with the touch roll. When the resin sheet is subjected to surface processing by being sandwiched and pressed between the main roll and the touch roll, the temperature of the resin sheet is equal to or higher than the glass transition temperature. Thus, the surface processability of the resin sheet can be surely improved.

### BRIEF DESCRIPTION OF THE ACCOMPANYING DRAWINGS

FIG. 1 is a schematic configuration diagram of a sheet/film molding apparatus in a conventional example.

FIG. 2 is a schematic configuration diagram of a sheet/film molding apparatus according to an embodiment of the present invention.

FIG. 3 is a cross-sectional view of a separating roll having a drive system of a rubber roll and an inlet-outlet structure of cooling water.

FIG. 4 is a cross-sectional view of the separating roll.

FIG. 5 is a cross-sectional view along the line V-V in FIG. 4.

FIG. 6 is a cross-sectional view along the line VI-VI in FIG. 4.

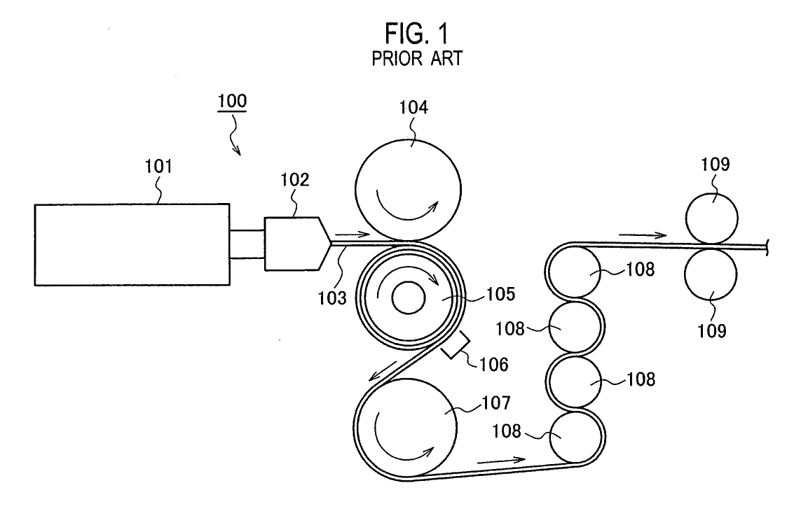

### DETAILED DESCRIPTION OF THE PREFERRED EMBODIMENTS

There will be detailed below the preferred embodiments of the present invention with reference to the accompanying drawings. Like members are designated by like reference characters.

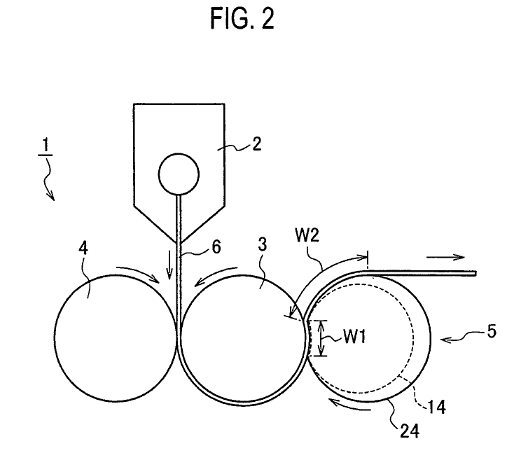

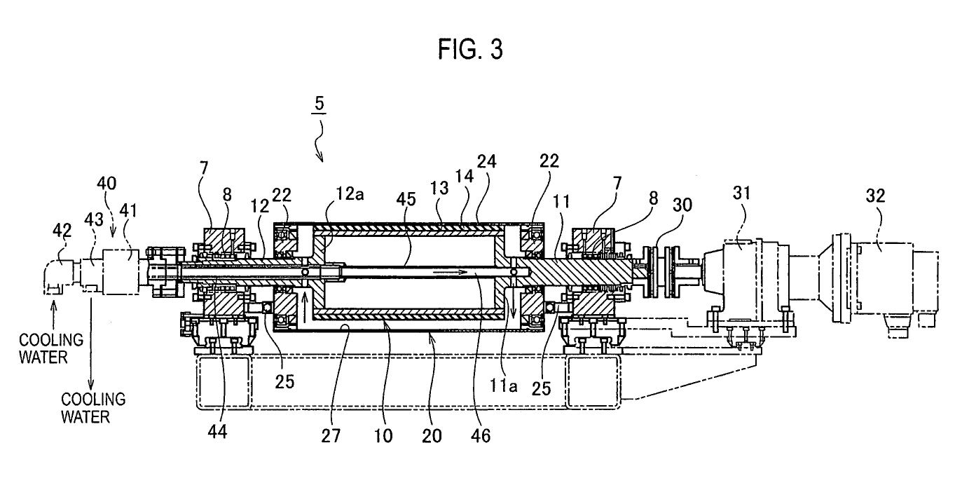

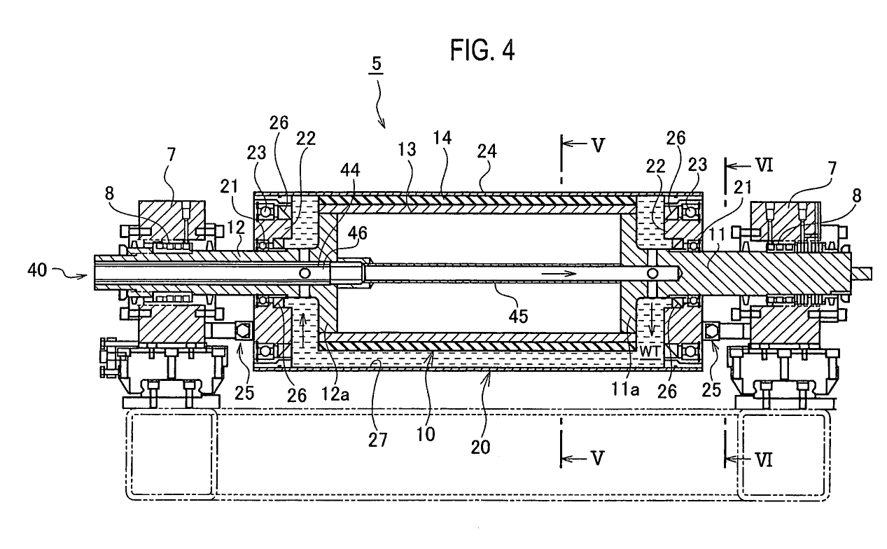

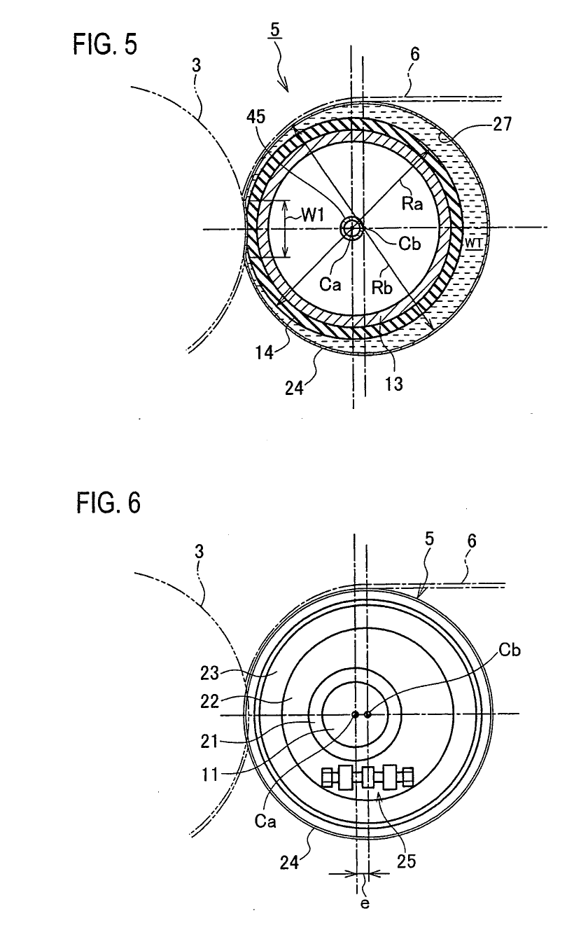

FIGS. 2 to 6 show an embodiment of the present invention. FIG. 2 is a schematic configuration diagram of a sheet/film molding apparatus 1. FIG. 3 is a cross-sectional view of a separating roll 5 having a drive system of a rubber roll 14 and an inlet-outlet structure of cooling water WT. FIG. 4 is a cross-sectional view of the separating roll 5. FIG. 5 is a cross-sectional view along the line V-V in FIG. 4. FIG. 6 is a cross-sectional view along the line VI-VI in FIG. 4.

As shown in FIG. 2, the sheet/film molding apparatus 1 includes: a T-die (T-dies) 2 connected to an extruding machine (not shown); a main roll 3 which is disposed below a resin extruding position on the T-die 2, and which is rotated and driven; a touch roll 4 disposed so as to make pressure contact with the main roll 3; and the separating roll 5 disposed on a conveying downstream side of the main roll 3.

A resin sheet 6 in a molten state, which is extruded from the T-die 2, is supplied to a pressing position between the main roll 3 and the touch roll 4. The resin sheet 6 passing the pressing position is wound around the main roll 3 over a predetermined range. Thereafter, the wound surface is continuously conveyed along a conveying path from the main roll 3 to the separating roll 5.

The main roll 3 is made of a rigid roll material and its unillustrated drive motor is rotated and driven by a drive source. The main roll 3 is set to a temperature equal to or higher than a glass transition temperature of the resin sheet 6. Thus, the resin sheet 6 is surely treated at the temperature equal to or higher than the glass transition temperature in a surface processing step in which the sheet is sandwiched and pressed between the main roll 3 and the touch roll 4. Moreover, as the main roll 3, used are those having different shapes of peripheral surfaces according to the surface processing mode of the resin sheet 6. The kinds of the main roll 3 to be used are as follows. Specifically, a mirror-surface roll is used to polish the surface of the resin sheet 6, an embossing roll is used to emboss the resin sheet 6, and a transfer roll is used to provide a desired transfer pattern on the resin sheet 6.

The touch roll 4 applies pressure to the resin sheet 6 by sandwiching and pressing the sheet with the main roll 3 and is rotated so as to follow the rotation of the main roll 3.

The separating roll 5 has a double-roll structure, in which cooling water WT that is a cooling medium is circulated. A configuration of the separating roll 5 will be described in detail below.

As shown in FIGS. 3 to 6, the separating roll 5 includes an inner roll body 10 and an outer roll body 20 having the inner roll body 10 housed therein. Specifically, the outer roll body 20 is eccentrically positioned to the rubber roll 14 in the inner roll body 10. Moreover, the cooling water WT that is the cooling medium is housed in the outer roll body 20.

The inner roll body 10 includes: a pair of left and right shaft members 11 and 12 rotatably supported on a pair of left and right fixed supporting members 7 through bearings 8; a pair of flanges 11a and 12a provided integrally with the shaft members 11 and 12, respectively; a cylindrical member 13 fixed in a state of being set on outer circumferences of the pair of flanges 11a and 12a; and the rubber roll 14 attached to a periphery of the cylindrical member 13. The rubber roll 14 is made of a rubber-like elastic body such as silicon and ethylene propylene rubber. It is preferable that a spiral groove or the like is formed on a peripheral surface of the rubber roll 14 in order to increase frictional force against a metal elastic external cylinder 24 to be described later.

A reducer (transmission) 31 and a motor 32 that is a drive source are connected to an end of one shaft member 11 with a coupling 30.

The outer roll body 20 includes: a pair of eccentric side plates 22 provided at positions outer than the flanges 11a and 12a of the pair of shaft members 11 and 12 through rolling bearings 21; and the metal elastic external cylinder 24 which are provided on peripheries of the pair of eccentric side plates 22 through rolling bearings 23 and arranged in a state of being set on the pair of eccentric side plates 22.

The metal elastic external cylinder 24 is made of a thin metal material, such as stainless steel, which is easily elastically deformed and has high thermal conductivity. An inside diameter Rb of the metal elastic external cylinder 24 is set larger than an outside diameter Ra of the rubber roll 14. The metal elastic external cylinder 24 is supported so as to be rotatable around the inner roll body 10 by setting a rotation center Cb thereof at a position eccentric to a rotation center Ca of the rubber roll 14 by e.

This eccentric arrangement allows the rubber roll 14 to make pressure contact with an inner peripheral surface of the metal elastic external cylinder 24 in a loaded state where the separating roll 5 makes pressure contact with the main roll 3 with the resin sheet 6 interposed therebetween. Moreover, in an unloaded state where the separating roll 5 makes no pressure contact with the main roll 3 with the resin sheet 6 interposed therebetween, the rubber roll 14 does not have contact with the inner peripheral surface of the metal elastic external cylinder 24. Thus, there may be a space (clearance) between the metal elastic external cylinder 24 and the rubber roll 14. By providing the space between the metal elastic external cylinder 24 and the rubber roll 14 in the unloaded state, assembly of the inner roll body 10 including the rubber roll 14 and the outer roll body 20 including the metal elastic external cylinder 24 is facilitated.

Moreover, rotations of the pair of eccentric side plates 22 are stopped by baffle members 25. As a result of this stopping of rotations, the rubber roll 14 comes in close contact with the inner peripheral surface of the metal elastic external cylinder 24 only at a certain spot. Moreover, the metal elastic external cylinder 24 comes in close contact with the main roll 3 at a spot outside the spot where the rubber roll 14 is in close contact with the inner peripheral surface.

Here, the main roll 3 is the rigid roll material, and, on the other hand, the rubber roll 14 and the metal elastic external cylinder 24 can be easily elastically deformed. Thus, as shown in FIGS. 2 and 5, the metal elastic external cylinder 24 is elastically deformed so as to follow the outer peripheral surface of the main roll 3. Accordingly, the metal elastic external cylinder 24 is pressed against the outer peripheral surface of the main roll 3 with a predetermined pressure-contact width W1 in a state where the resin sheet 6 is sandwiched and pressed between the metal elastic external cylinder 24 and the main roll 3.

Between the respective eccentric side plates 22 and the metal elastic external cylinder 24 as well as between the respective shaft members 11 and 12 and the eccentric side plates 22, seal members 26 are provided to seal spaces therebetween. Thus, inside the metal elastic external cylinder 24, more specifically, an internal space surrounded by the metal elastic external cylinder 24, the pair of eccentric side plates 22 and the pair of shaft members 11 and 12 is formed as a liquid-tight cooling water holding chamber 27 (a cooling medium holding chamber). This cooling water holding chamber 27 is approximately filled with the cooling water WT. Moreover, the cooling water WT is replaced with sufficiently cooled water outside by the following cooling water circulator 40.

The cooling water circulator 40 includes: a cooling water supply nipple 42 and a cooling water discharge nipple 43, which are connected to an end of the other shaft member 12 with a rotary joint 41 interposed therebetween; a water discharge channel 44 formed inside the other shaft member 12; and a water supply channel 46 formed of the one shaft member 11, a connecting pipe 45 and the other shaft member 12. The cooling water WT supplied from the cooling water supply nipple 42 is sent to the cooling water holding chamber 27 through the water supply channel 46. Meanwhile, the cooling water WT in the cooling water holding chamber 27 is discharged from the cooling water discharge nipple 43 through the water is discharge channel 44. Such a circulation of the cooling water WT allows the metal elastic external cylinder 24 to be efficiently cooled from the inside by the cooling water WT that is always sufficiently cooled.

Next, description will be given of an operation of molding the resin sheet 6 by the sheet/film molding apparatus 1 described above. When the main roll 3 and the separating roll 5 are both rotated and driven, the touch roll 4 is rotated so as to follow the rotation of the main roll 3 as indicated by the arrow in FIG. 2. Moreover, the metal elastic external cylinder 24 is rotated so as to follow the rotation of the rubber roll 14 in the separating roll 5. Accordingly, in the state where the respective rolls 3 to 5 are rotated as described above, the resin sheet 6 in a molten state is supplied between the main roll 3 and the touch roll 4 from the T-die 2.

The resin sheet 6 in the molten state, which is extruded from the T-die 2, is subjected to surface processing (mirror polishing, embossing, pattern transfer and the like) at a position sandwiched and pressed between the main roll 3 and the touch roll 4. The surface-processed resin sheet 6 is conveyed over a certain winding range along the outer peripheral surface of the main roll 3. In the last half of winding and conveying by the main roll 3, the resin sheet 6 is pressed against the metal elastic external cylinder 24 of the separating roll 5. Thereafter, the wound surface is moved from the outer peripheral surface of the main roll 3 to the outer peripheral surface of the metal elastic external cylinder 24 of the separating roll 5. Subsequently, the resin sheet 6 is conveyed by a certain winding width W2 along the metal elastic external cylinder 24 of the separating roll 5. The resin sheet 6 continuously supplied from the T-die 2 is continuously molded as a product sheet by continuously performing the steps described above.

In the sheet molding process described above, at the position where the resin sheet 6 is sandwiched and pressed between the main roll 3 and the touch roll 4 immediately after the resin sheet 6 is extruded from the T-die 2, a temperature of the resin sheet is set to be equal to or higher than a glass transition temperature of resin. Thus, high fluidity of the resin allows accurate surface processing to be performed by the main roll 3. Moreover, within the range in which the metal elastic external cylinder 24 of the separating roll 5 is pressed against the resin sheet 6 in a state where the resin sheet 6 is sandwiched and pressed between the main roll 3 and the separating roll 5, the metal elastic external cylinder 24 of the separating roll 5 is thin and easily elastically deformed. Moreover, the metal elastic external cylinder 24 is pressed against the outer peripheral surface of the main roll 3 with a certain pressure-contact width W1. Thus, the resin sheet 6 is cooled over the pressure-contact width W1 by the metal elastic external cylinder 24 cooled by the cooling water inside. Therefore, at a position where the resin sheet 6 is separated from (peeled off) the main roll 3, the resin sheet 6 is sufficiently cooled and its temperature is lowered below the glass transition temperature. As a result, the fluidity of the resin is lost and thus the resin sheet is smoothly separated.

As described above, the separating roll 5 also serves as a cooler configured to cool the resin sheet 6. Thus, surface processability as well as detachability of the resin sheet 6 can be improved without adding dedicated parts for cooling the resin sheet 6.

Moreover, the resin sheet 6 separated from the main roll 3 is immediately wound around the metal elastic external cylinder 24 of the separating roll 5 over the winding width W2 and conveyed. Thus, since the resin sheet is continuously cooled by the thin metal elastic external cylinder 24, there is an advantage that cooling efficiency is better than that in the conventional case.

In this embodiment, the separating roll 5 is configured so as to allow the rubber roll 14 to be rotated and driven by the motor 32. Accordingly, the resin sheet 6 can be separated from the main roll 3 while applying tension to the resin sheet 6 in a conveying direction by the separating roll 5. Thus, the resin sheet 6 can be separated without causing the sheet to be bent, wrinkled or the like.

In this embodiment, the main roll 3 is set to the temperature equal to or higher than the glass transition temperature of the resin sheet 6. At the position where the metal elastic external cylinder 24 makes pressure contact with the main roll 3 with the resin sheet 6 interposed therebetween, the main roll 3 is cooled at the spot around the pressure contact position by the metal elastic external cylinder 24. Thus, the temperature of the main roll 3 may be temporarily lowered below the glass transition temperature. However, the set temperature of the main roll 3 is equal to or higher than the glass transition temperature of the resin. Thus, the temperature of the main roll 3 is set back to be equal to or higher than the glass transition temperature of the resin while the main roll is rotated to the pressing position with the touch roll 4. Accordingly, when the resin sheet 6 is subjected to surface processing by being sandwiched and pressed between the main roll 3 and the touch roll 4, the temperature of the resin sheet 6 can be surely maintained to be equal to or higher than the glass transition temperature. Thus, the surface processability of the resin sheet 6 can be surely improved.

Note that this application claims the benefit of Japanese Patent Application No. 2007-139611 (filed on May 25, 2007) which is hereby incorporated by reference herein in its entirety.

Although the invention has been described above by reference to certain embodiments of the invention, the invention is not limited to the embodiments described above. Modifications and variations of the embodiments descried above will occur to those skilled in the art, in light of the above teachings. The scope of the invention is defined with reference to the following claims.

What is claimed is:

1. A sheet/film molding apparatus, comprising:
a touch roll;
a main roll which sandwiches and presses, with the touch roll, a resin sheet extruded in a molten state from a T-die, and which conveys the sandwiched and pressed resin sheet along an outer peripheral surface of the main roll; and
a separating roll which separates the resin sheet from the outer peripheral surface of the main roll, and which conveys the separated resin sheet along an outer peripheral surface of the separating roll,
wherein
the separating roll has a rubber roll and a metal elastic external cylinder which has the rubber roll housed therein, which is eccentrically positioned to the rubber roll, and which is thin and easily elastically deformed;
a cooling medium holding chamber into which a cooling medium is supplied is provided between the rubber roll and the metal elastic external cylinder;
the resin sheet between the main roll and the metal elastic external cylinder is cooled by allowing the rubber roll to make pressure contact with an inner peripheral surface of the metal elastic external cylinder; and
the separating roll separates the resin sheet from the outer peripheral surface of the main roll.

2. The sheet/film molding apparatus according to claim 1, wherein
the rubber roll is rotated and driven by a drive source.

3. The sheet/film molding apparatus according to one of claim 1, wherein
the main roll is set to a temperature not lower than a glass transition temperature of the resin sheet.

4. The sheet/film molding apparatus according to one of claim 2, wherein
the main roll is set to a temperature not lower than a glass transition temperature of the resin sheet.

5. A sheet/film molding method, comprising the steps of:
sandwiching and pressing, between a main roll and a touch roll, a resin sheet extruded in a molten state from a T-die;
separating the resin sheet from the main roll by use of a separating roll, the resin sheet being conveyed along an outer peripheral surface of the main roll; and
conveying the separated resin sheet along an outer peripheral surface of the separating roll,
wherein
the separating roll has a rubber roll and a metal elastic external cylinder which has the rubber roll housed therein, which is eccentrically positioned to the rubber roll, and which is thin and easily elastically deformed;
a cooling medium is supplied between the rubber roll and the metal elastic external cylinder of the separating roll;
the resin sheet between the main roll and the metal elastic external cylinder of the separating roll is cooled by allowing the rubber roll of the separating roll to make pressure contact with an inner peripheral surface of the metal elastic external cylinder, and
the separating roll separates the resin sheet from the outer peripheral surface of the main roll.

6. The sheet/film molding method according to claim 5, wherein
the rubber roll of the separating roll is rotated and driven by a drive source.

7. The sheet/film molding method according to one of claim 5, wherein
a temperature of the resin sheet when the resin sheet is sandwiched and pressed between the main roll and the touch roll is set to be not lower than a glass transition temperature of resin.

8. The sheet/film molding method according to one of claim 6, wherein
a temperature of the resin sheet when the resin sheet is sandwiched and pressed between the main roll and the touch roll is set to be not lower than a glass transition-temperature of resin.
